(19) United States
(12) Patent Application Publication
(10) Pub. No.: US 2009/0224040 A1
(43) Pub. Date: Sep. 10, 2009

(54) ITEM MANAGEMENT SYSTEM AND INFORMATION PROCESSING DEVICE

(75) Inventors: Hiroyuki KUSHIDA, Kanagawa (JP); Shinji Saegusa, Shizuoka (JP)

Correspondence Address: PATTERSON & SHERIDAN, L.L.P., 3040 POST OAK BOULEVARD, SUITE 1500, HOUSTON, TX, 77056, US

(73) Assignee: Toshiba Tec Kabushiki Kaisha, Tokyo (JP)

(21) Appl. No.: 12/393,138

(22) Filed: Feb. 26, 2009

(30) Foreign Application Priority Data
Mar. 7, 2008 (JP) 2008-057197

(51) Int. Cl. G06F 19/00

(52) U.S. Cl. 235/385

(57) ABSTRACT

The article management system comprises an item placement position memory unit that stores item identification information and item position information, a wireless tag reading unit that reads a wireless tag attached to the item and outputs wireless tag readout information, an item identification information acquiring unit that acquires the item identification information of the item based on the wireless tag readout information output by the wireless tag reading unit, an object detecting unit that detects an object approaching the placement unit and outputs object position information, an item position identifying unit that associates the item identification information and the object position information and outputs the associated information as item position identification information, and an item position determining unit that compares the item position identification information with the item position information stored in the memory unit and outputs a comparison result.

### CROSS-REFERENCE TO RELATED APPLICATIONS

This application is based upon and claims the benefit of priority from prior Japanese Patent Application No. 2008-057197, filed Mar. 7, 2008, the entire contents of which are incorporated herein by reference.

### BACKGROUND OF THE INVENTION

1. Field of the Invention

The present invention relates to an item management system and an information processing device for managing items such as retail products and parts.

2. Description of the Related Art

In a store or warehouse, management tasks for items such as retail products and parts are usually conducted by a store clerk or a warehouse worker by visual checking. Such tasks, however, are time-consuming and thus difficult to perform in an efficient manner. Furthermore, errors can be easily made. For these reasons, a system that reduces human work has been sought. Recently, wireless IC tags such as Radio Frequency Identification (RFID) tags have been developed. Jpn. Pat. Appln. KOKAI Publication No. 2001-031218 suggests a merchandise management system, in which an RFID tag with an identification code of a retail product written therein is attached to the product to manage products in a store or warehouse.

According to this document, a reading unit that exchanges signals with RFID tags is provided in each display section. Each section is given an individual address so that merchandise management can be conducted in accordance with identification codes transmitted from the reading unit and addresses of the sections.

On retail premises such as a convenience store, various kinds of products having relatively small outer dimensions are often displayed in limited spaces. Products of each kind are placed in a tight section of space, and products of similar kinds are packed next to one another. As an important factor of sales strategy in a store, items that are receiving attention need to be displayed at a position that customers can easily find. For this reason, regardless of the tightness of the display space, it is important to accurately identify the display positions of products and manage them so that the products are always displayed at predetermined positions. In a warehouse also, it is necessary, when carrying products or parts in and out, to identify where the items are stored and manage them so that they are always stored at predetermined positions.

The system disclosed in the above patent document identifies the position of a product in accordance with the address of the section where the reading unit is placed. If each display section is defined to have a large area, the distance between the reading units individually positioned in the sections is increased, which makes the locating of the display position unclear. If each display section is defined to have a small area, the distance between the reading units of the sections is shortened. Then, it is difficult to accurately locate the display position because the reading units may cause interference with one another, or may mistakenly read a RFID tag of an adjacent section.

### BRIEF SUMMARY OF THE INVENTION

The purpose of the present invention is to offer an item management system and an information processing device for managing the locations of items in a store or a warehouse.

The item management system according to an embodiment of the present invention comprises an item placement position memory unit that stores item identification information of an item placed on a placement unit and item position information which indicates a position at which the item is placed; a wireless tag reading unit that reads a wireless tag attached to the item and outputs wireless tag readout information; an item identification information acquiring unit that acquires the item identification information of the item based on the wireless tag readout information output by the wireless tag reading unit; an object detecting unit that detects an object approaching the placement unit that carries the item thereon and outputs object position information; an item position identifying unit that associates the item identification information and the object position information with each other and outputs associated information as item position identification information; and an item position determining unit that compares the item position identification information output by the item position identifying unit with the item position information stored in the item placement position memory unit and outputs a comparison result.

Additional advantages of the invention will be set forth in the description which follows, and in part will be obvious from the description, or may be learned by practice of the invention. The advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a diagram of a system structure according to the first embodiment of the present invention.

FIG. 2 is a diagram of a hardware structure of a sensor according to the embodiment.

FIG. 3 is a diagram of a hardware structure of a RFID tag reader according to the embodiment.

FIG. 4 is a diagram of a hardware structure of a system management unit according to the embodiment.

FIG. 5 is a diagram of a structure of the sensor according to the embodiment.

FIG. 6 is a diagram of a structure of a sensor unit and a product display shelf unit according to the embodiment.

FIG. 7 is a diagram of a structure of a sensor unit and a product display shelf unit according to the embodiment.

FIG. 8 is a diagram showing the data structure of an object position data table according to the embodiment.

FIG. 9 is a diagram showing the data structure of an effective area table according to the embodiment.

FIG. 10 is a diagram showing the data structure of a planogram table according to the embodiment.

FIG. 11 is a diagram showing the data structure of a RFID tag memory table according to the embodiment.

FIG. 12 is a diagram showing the data structure of a RFID tag data buffer according to the embodiment.

FIG. 13 is a diagram showing the data structure of a RFID tag data table according to the embodiment.

FIG. 14 is a diagram showing the data structure of an item position identification table according to the embodiment.

FIG. 15 is a diagram showing a display screen of an output unit of a system management unit according to the embodiment.

FIG. 16 is a diagram showing another display screen of the output unit of the system management unit according to the embodiment.

FIG. 17 is a flowchart showing the procedure of a main process of the item management system according to the embodiment.

FIG. 18 is a flowchart showing the procedure of an object detecting process according to the embodiment.

FIG. 19 is a flowchart showing the procedure of a RFID tag reading process according to the embodiment.

FIG. 20 is a flowchart showing the procedure of an item position identifying process according to the embodiment.

FIG. 21 is a flowchart showing the procedure of a main process of an item management system according to the second embodiment of the present invention.

### DETAILED DESCRIPTION OF THE INVENTION

### Embodiment 1

Exemplary embodiments of the present invention will be explained with reference to the attached drawings.

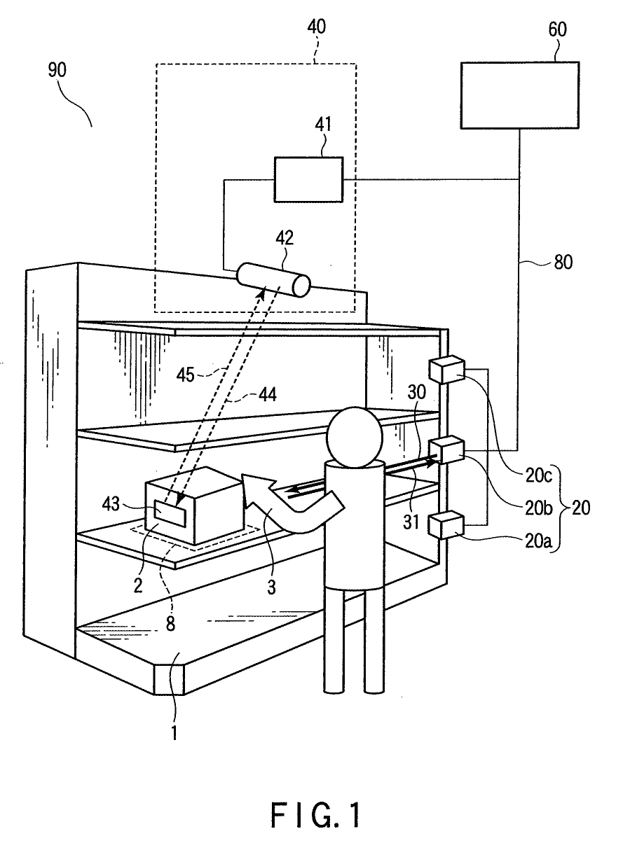

FIG. 1 is a diagram of a structure of an item management system 90 according to the first embodiment of the present invention. The item management system 90 comprises a sensor unit 20 (object detecting unit), a RFID tag reader unit 40 (wireless tag reading unit), and a system management unit 60 (information processing device).

A sensor unit 20 is composed of sensors 20a, 20b and 20c that are arranged in correspondence with individual shelves of a product display shelf unit 1 (placement unit) in a retail store. The sensor unit 20 detects a product 2 (item) placed on the product display shelf unit 1 or an object 3 approaching a product display area 8 (item placement area), and measures the distance between the corresponding sensor and the object 3. The sensor unit 20 transmits the measured distance to the system management unit 60 as object position data (object position information) of the object 3. Because the sensors 20a, 20b and 20c have the same hardware structure and the same function, the sensor 20b will be mainly discussed as an object detecting unit in the present embodiment.

The sensor 20b can measure the distance from the object 3 by a method of adopting an infrared laser beam. According to this method, projection light 30, which is an infrared laser beam having a wavelength of 0.7 μm to 0.1 mm, is projected from the sensor 20b onto the object 3, and reflection light 31 reflected from the object 3 is detected by the sensor 20b. Based on a time difference between the time at which the projection light 30 is projected and the time at which the reflection light 31 is detected, the distance from the object 3 is calculated. The to-be-detected object 3 may be the hand or arm of a store clerk or a person who is carrying merchandise in and out, or may be the merchandise itself. The object 3 also could be an arm of a merchandise carrying robot or the like.

The RFID tag reader unit 40 is composed of a RFID tag reader 41 and an antenna 42. The RFID tag reader 41 modulates a read signal to read a RFID tag 43. The antenna 42 sequentially transmits read waves 44 that are obtained as a result of the modulation by the RFID tag reader 41. The antenna 42 also receives response waves 45 from the RFID tag 43. When the antenna 42 receives response waves 45 from a RFID tag 43 located in the communication area, the RFID tag reader 41 demodulates the radio waves and stores response data in the RFID tag reader 41. The response data is RFID tag readout data (wireless tag readout information) recorded in the RFID tag 43, including a tag code, which is a tag identification code, and product data such as a product code for identifying a product and the name of the product.

The system management unit 60 is connected to the sensor unit 20 and the RFID tag reader unit 40 on a communications line 80 such as a LAN or a dedicated line. The system management unit 60 performs a process based on the object position data of the object 3 output by the sensors and the RFID tag readout data acquired from the RFID tag reader unit 40.

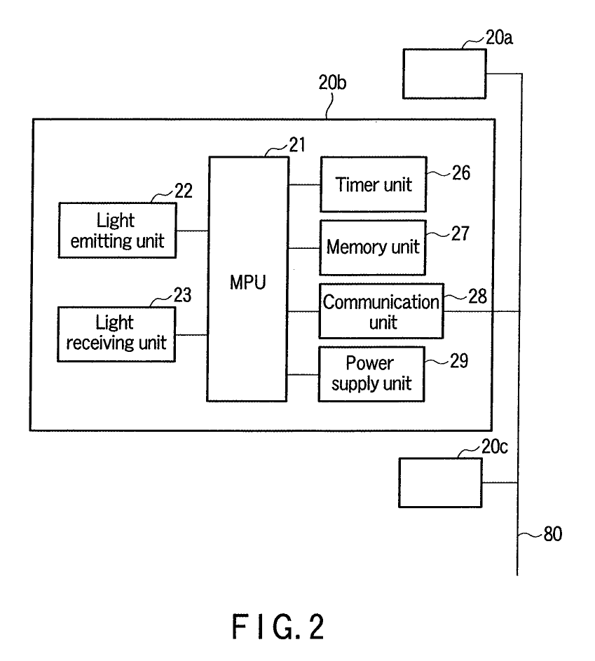

FIG. 2 is a diagram showing a hardware structure of the sensor 20b of the item management system 90. The sensor 20b comprises a micro processing unit (MPU) 21, a light emitting unit 22 (light projecting unit), a light receiving unit 23 (detecting unit), a timer unit 26, a memory unit 27, a communication unit 28, a power supply unit 29, and the like. The MPU 21 is a controller that controls the hardware units of the sensor 20b. The light emitting unit 22 emits the projection light 30 to detect the object 3. The light receiving unit 23 detects reflection light 31 from the object 3. The memory unit 27 is a hard disk or a memory. The communication unit 28 exchanges data with the system management unit 60.

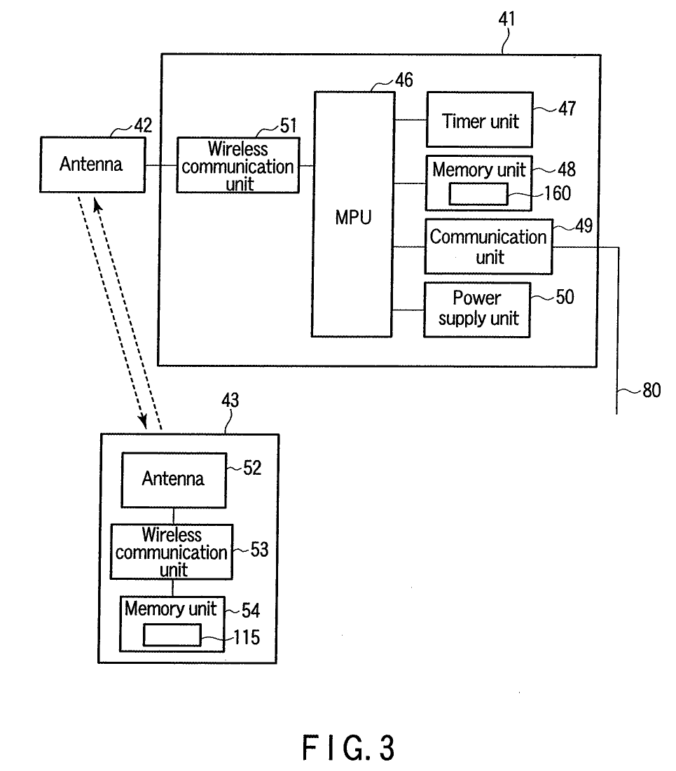

FIG. 3 is a diagram showing the hardware structure of the RFID tag reader unit 40 of the item management system 90. The RFID tag reader unit 40 includes the RFID tag reader 41 and the antenna 42. The RFID tag reader 41 includes a micro processing unit (MPU) 46, a timer unit 47, a memory unit 48, a communication unit 49, a power supply unit 50, a wireless communication unit 51, and the like. The MPU 46 is a controller that controls the hardware units. The memory unit 48 is a memory or the like. The communication unit 49 exchanges data with the system management unit 60. The wireless communication unit 51 conducts communications with the RFID tag 43 by way of the antenna 42. The memory unit 48 of the RFID tag reader 41 includes a RFID tag data buffer 160 to store a tag code, a product code and the name of the product received from the RFID tag 43. The RFID tag 43 is composed of an antenna 52, a wireless communication unit 53, and a memory unit 54. The memory unit 54 includes a RFID tag memory table 115.

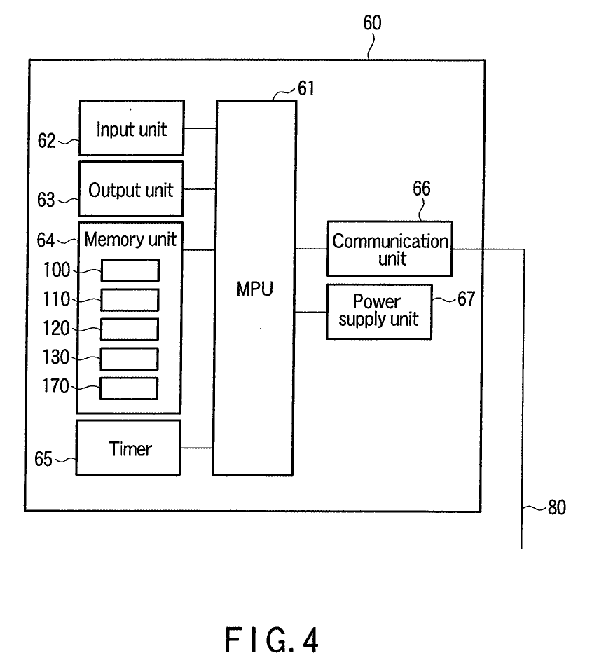

FIG. 4 is a diagram for showing the hardware structure of the system management unit 60 of the item management system 90. The system management unit 60 includes a micro processing unit (MPU) 61, an input unit 62, an output unit 63, a memory unit 64, a timer unit 65, a communication unit 66, a power supply unit 67, and the like. The MPU 61 is a controller that controls the hardware units. The input unit 62 is an input device such as a keyboard and a mouse. The output unit 63 is an output device including a display such as a liquid crystal display or an organic EL display, and a printer. The memory unit 64 is a hard disk or a memory. The communication unit 66 exchanges data with the sensor unit 20, the RFID tag reader unit 40 or any other system. The memory unit 64 holds a location data table 100, an effective area table 110, a RFID tag data table 120, an item position identification table 130, and a planogram table 170.

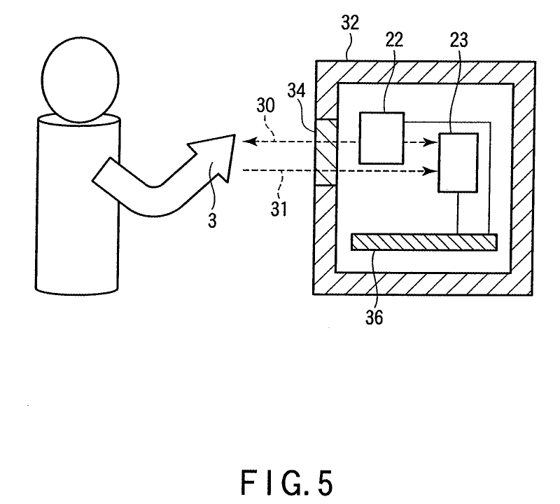

Next, the sensor 20b, which serves as the object detecting unit of the item management system 90, will be explained. FIG. 5 is a diagram showing the structure of the sensor 20b. The sensor 20b comprises the light emitting unit 22 (light projecting unit), the light receiving unit 23 (detecting unit), a housing 32, a sensor controlling unit 36, and the like. The housing 32 is shaped into a cylinder and has a transparent window 34 formed to open 180 degrees in the circumferential direction. The light emitting unit 22 is a light source of an infrared laser or LED. The light receiving unit 23 may be a light sensor such as a photodiode.

The sensor controlling unit 36 functions as an object position calculating unit. The sensor controlling unit 36 comprises the MPU 21, the timer unit 26, the memory unit 27, the communication unit 28, the power supply unit 29 and the like. The sensor controlling unit 36 controls the emission of the light emitting unit 22, and measures and calculates the distance between the sensor 20b and the object 3.

The distance calculation by use of the projection light 30 and the reflection light 31 may be a method using a time difference between the time of emission of the projection light 30 and the time of detection of the reflection light 31, or by a method using a phase difference between the projection light 30 and the reflection light 31. According to the time difference method, the light emitting unit 22 emits an infrared laser beam as projection light 30 in the form of short pulses, and the light receiving unit 23 detects the reflection light 31 of this beam. The MPU 21 calculates the distance based on a difference between the time of emission of the projection light 30 and the time of detection of the reflection light 31, the length of time that it has taken for the light to travel from the projection light 30 and back, and the reference speed of the projection light 30 and the reflection light 31. According to the phase difference method, the infrared laser beam incident from the light emitting unit 22 is modulated with a sinusoidal wave that maintains a certain frequency, and the distance is calculated based on the difference between the phases of the projection light 30 and the reflection light 31. With the phase difference method, the distance cannot be calculated if the phase difference is larger than one cycle. Thus, the frequency for the modulation should be determined within a predetermined detection area. According to the present embodiment, the sensor 20b measures the distance from the object 3 by use of the projection light 30, which is an infrared laser beam. In the same manner as the infrared laser beam, an ultrasonic wave, which is a sonic wave having a frequency of 20 kHz or higher, may be projected, and the reflection wave may be detected. Then, the distance from the object 3 can be calculated based on the time of projection of the ultrasonic wave and the time of detection of the reflection wave.

The sensor controlling unit 36 calculates the distance from the sensor 20b to the object 3 based on the difference between the time at which the light emitting unit 22 emits the projection light 30 and the time at which the light receiving unit 23 detects the reflection light 31 in accordance with the above method. The sensor controlling unit 36 transmits to the system management unit 60 the object position data, which includes the calculated distance data, the sensor identification data that identifies the sensor 20b, and the sensor detection time data that represents the time of detection of the reflection light 31. Upon receipt of the object position data from the sensor 20b, the system management unit 60 executes the process based on the data.

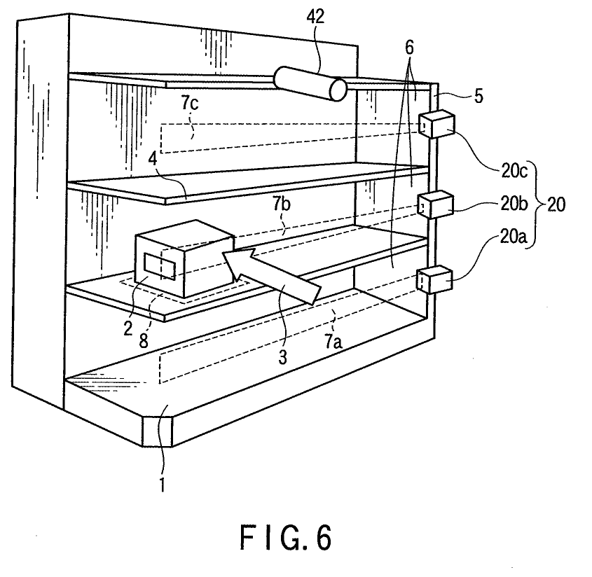

FIG. 6 is a diagram of the product display shelf unit 1 (placement unit) provided with the sensor unit 20 which includes the sensors 20a, 20b and 20c. The sensors detect the product 2 (item) displayed in the product display shelf unit 1 or the object 3 approaching the product display area 8 (item placement area) of the product 2. The sensor unit 20 may be situated on the peripheral portion 5 of the front side 4 of the product display shelf unit 1, where a product loading area 6 (opening) is provided. The projection light 30 horizontally projected from the sensors 20a, 20b and 20c has a certain width, and therefore detection areas 7a, 7b and 7c are created in the form of bands across the front of the product loading area 6 to serve as reference areas in detection of the object 3.

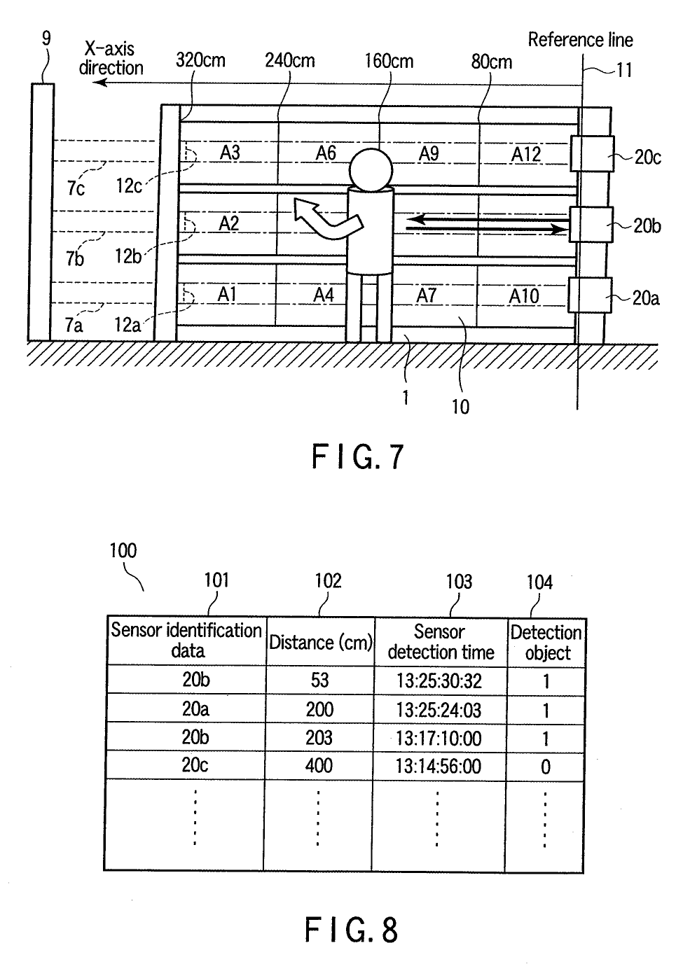

FIG. 7 is a diagram of the product display shelf unit 1 that is sectioned into blocks 10, A1 to A12, in order to display different kinds of products 2. The areas of the blocks Al to A12 are determined in accordance with the sizes of the sections in which the products 2 are displayed. According to the present embodiment, all the blocks A1 to A12 have the same size, 50 cm long and 80 cm wide, but the size is not limited thereto. The blocks A1 to A12 may be determined to have different sizes. According to the present embodiment, the product display shelf unit 1 is 320 cm wide in the X-axis direction, when referring to a reference line 11 connecting the positions of the sensors 20a, 20b and 20c. The detection areas 7a, 7b and 7c defined by the projection light 30 incident from the sensors 20a, 20b and 20c are laid across the product loading area 6 of the product display shelf unit 1 in the form of bands. For this reason, the sensors 20a, 20b and 20c detect not only the product 2 displayed in the product display shelf unit 1 or the object 3 approaching the product display area 8, but also fixed background objects 9, including pillars and walls of the retail premises on which the product display shelf unit 1 is situated, a store clerk or a customer standing next to the product display shelf unit 1, and moving objects such as a cart and other equipment. The item management system 90 is supposed to identify the position of the product 2 displayed in the product display shelf unit 1, and thus the positional data of the background objects should be excluded from detection targets. The system management unit 60 according to the present invention determines the rear end of the product display shelf unit 1 in the X-axis direction as the upper limit of the effective detection area in order to exclude the positional data of those background objects. The system management unit 60 performs a process of excluding the positional data of any object detected beyond effective detection areas 12a, 12b and 12c, which are part of the detection areas 7a, 7b and 7c between the sensors 20a, 20b and 20c and the upper limit.

FIG. 8 is a diagram showing the structure of an object position data table 100 stored in the memory unit 64 of the system management unit 60. The object position data table 100 includes a sensor identification data field 101, a distance field 102, a sensor detection time field 103, and a detection object field 104. The sensor identification data field 101 maintains the sensor identification data that is output by the sensors 20a, 20b and 20c to identify the sensors. The distance field 102 maintains the distance data. The sensor detection time field 103 maintains the detection time data representing the time at which the object is detected. The sensor identification data, the distance data and the detection time data constitute the object position data. The detection object field 104 holds “1” when the positional data is judged as data of a detection target in the effective information extracting process, while the detection object field 104 holds “0” when the positional data is not judged as data of a detection target. Whether the object can be a detection target is determined based on the data in the detection object field 104.

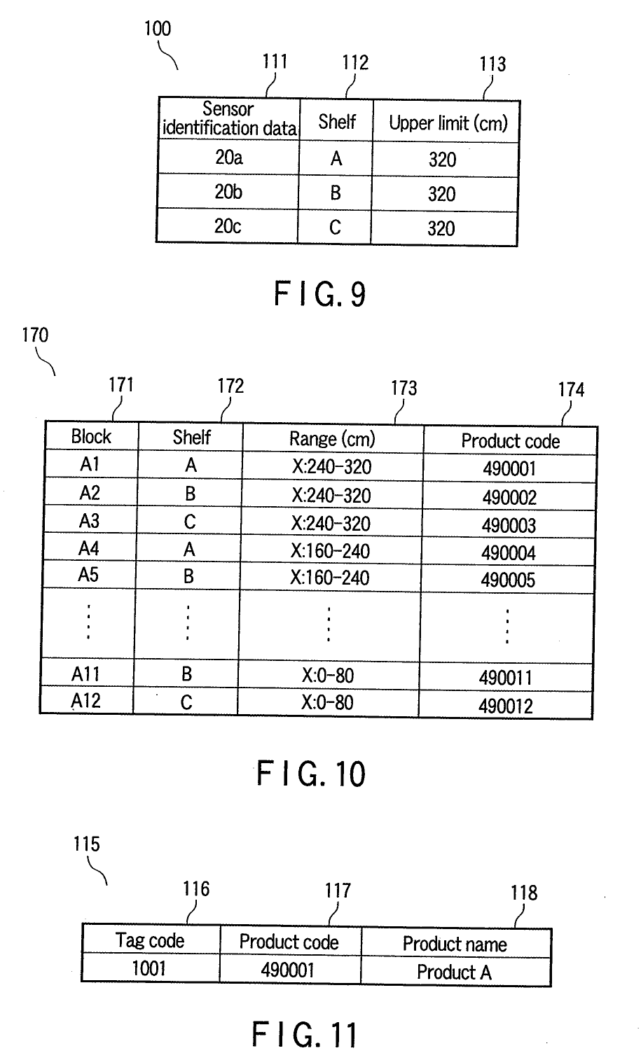

FIG. 9 is a diagram showing the structure of the effective area table 110 stored in the memory unit 64 of the system management unit 60. The effective area table 110 functions as an effective area memory unit. The effective area table 110 maintains the upper limits of the sizes of the effective detection areas 12a, 12b and 12c that are included in the detection areas 7a, 7b and 7c defined by the sensors 20a, 20b and 20c. The effective area table 110 includes a sensor identification data field 111 that holds identification data of each sensor, a shelf field 112 that holds shelf data to identify the shelf on which the sensor is provided, and an upper limit field 113 that holds the upper limit of the effective detection area (area information) for each sensor. According to the present embodiment, the upper limit field 113 holds the upper limit of 320 cm, which is the dimension of the product display shelf unit 1. The positional data beyond this limit is eliminated from the data of the detection targets in the effective information extracting process because it can be considered as background position data of a background object 9 or the like that is positioned outside the effective detection areas 12a, 12b, and 12c but is detected by the projection light 30 reflected thereon.

FIG. 10 is a diagram showing the structure of the planogram table 170 stored in the memory unit 64 of the system management unit 60. The planogram table 170 serves as an item placement position memory unit. The planogram table 170 includes, in association with a block field 171, a shelf field 172 that holds the shelves on which the blocks Al to A12 of the product display shelf unit 1 are positioned, a range field 173 that holds the positional ranges of the blocks, and a product code field 174 that holds the product codes (item identification information) of the products 2 (items) displayed in the blocks. The range data stored in the range field 173 represents the range of a block in the X-axis direction, when referring to the reference line 11 that connects the sensors 20a, 20b and 20c of the product display shelf unit 1 to one another. The block data in the block field 171 serves as item position information.

FIG. 11 is a diagram showing the structure of the RFID tag memory table 115 stored in the memory unit 54 of the RFID tag 43. The RFID tag memory table 115 includes a tag code field 116 that holds tag codes for identifying RFID tags, a product code field 117 that holds product codes for identifying the products, and a product name field 118 that holds the names of the products.

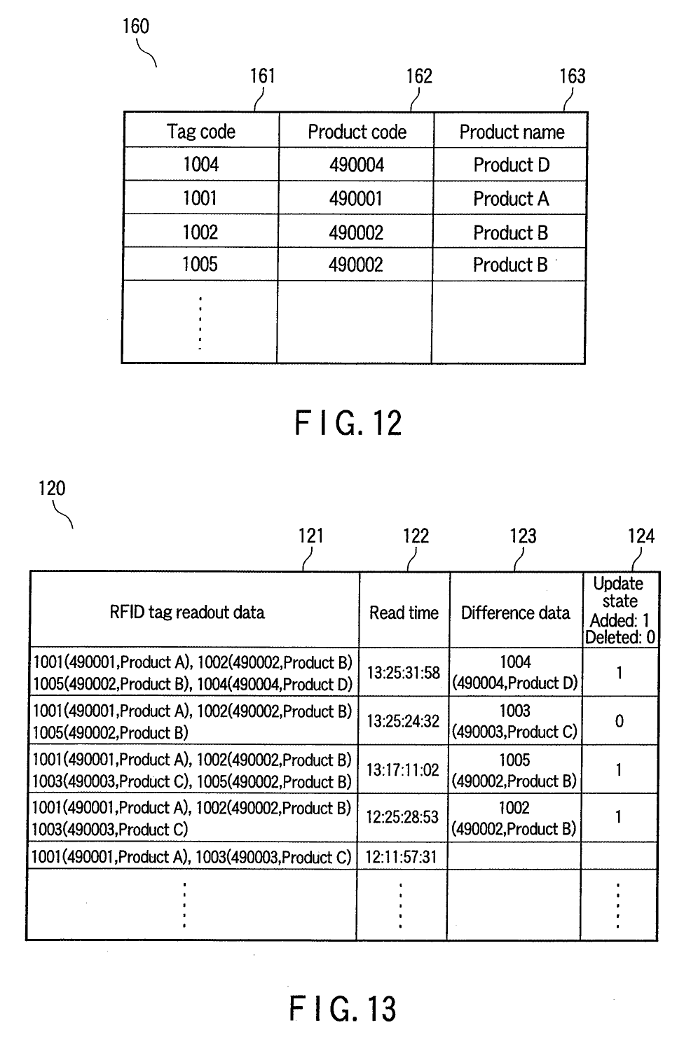

FIG. 12 is a diagram showing the structure of the RFID tag data buffer 160 stored in the memory unit 48 of the RFID tag reader 41. The RFID tag data buffer 160 includes a tag code field 161, a product code field 162, and a product name field 163.

FIG. 13 is a diagram showing the structure of the RFID tag data table 120 stored in the memory unit 64 of the system management unit 60. The RFID tag data table 120 includes a RFID tag readout data field 121, a read time field 122, a difference data field 123 and an update state field 124.

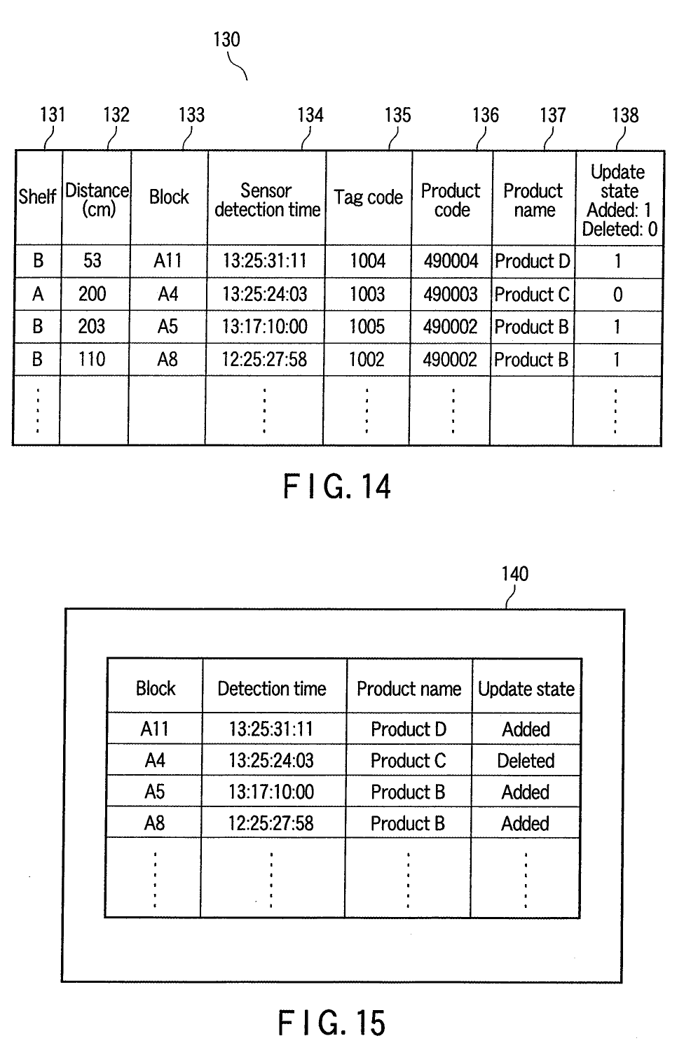

FIG. 14 is a diagram showing the structure of the item position identification table 130 stored in the memory unit 64 of the system management unit 60. The item position identification table 130 includes a shelf field 131 that holds the object position data, a distance field 132, a block field 133, a sensor detection time field 134, a tag code field 135, a product code field 136, a product name field 137, and an update state field 138.

FIG. 15 is a diagram of a display screen 140. The display screen 140 is output on the output unit 63 of the system management unit 60 such as a liquid crystal display or an organic EL display.

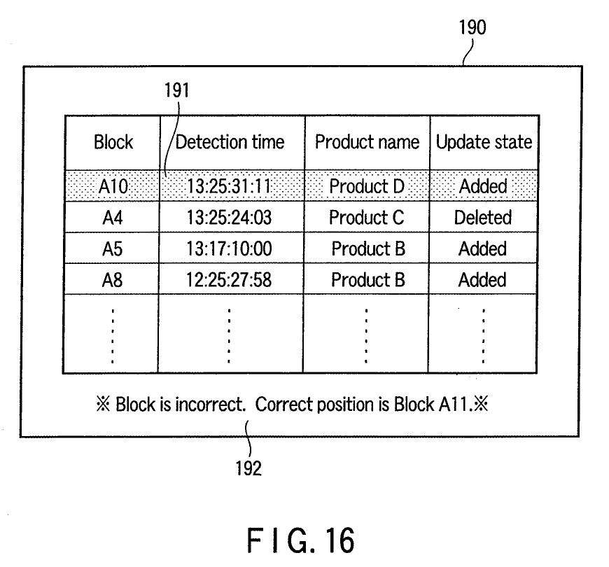

FIG. 16 is a diagram of a display screen 190. The display screen 190 serves as item position warning information. The display screen 190 is output onto the output unit 63 of the system management unit 60 such as a liquid crystal display and an organic EL display. The display screen 190 includes display entries 191 of item position identification information in which an error is made, an error message 192, and the like.

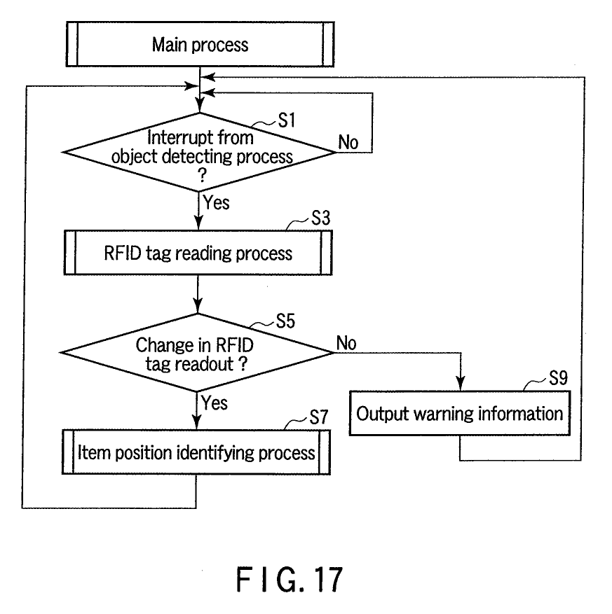

Next, the process performed by the item management system 90 is explained with reference to the flowcharts of FIGS. 17 to 20. FIG. 17 is a flowchart of the main process executed by the MPU 61, which is the controller of the system management unit 60. The MPU 61 of the system management unit 60 awaits an interrupt from the object detecting process that is performed when the sensor unit 20 detects the object 3 (Step S1).

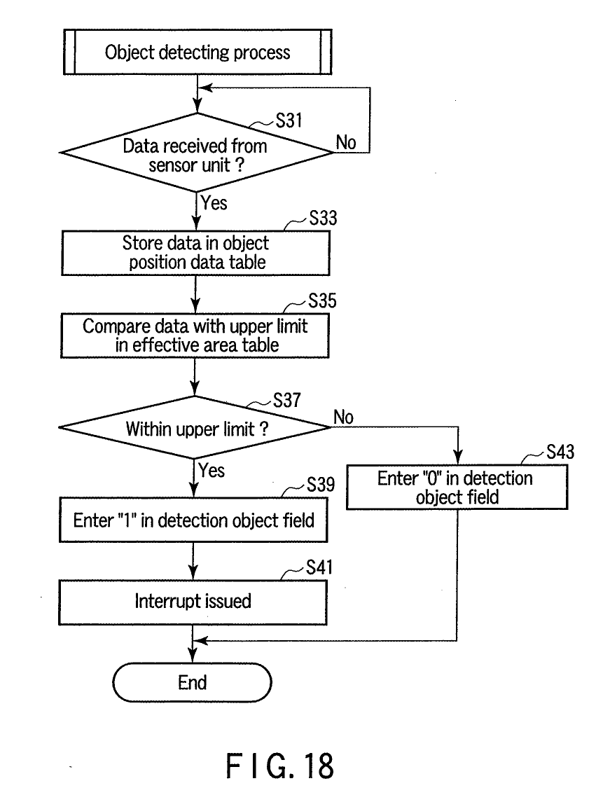

The object detecting process is now explained. FIG. 18 is a flowchart of the object detecting process executed by the MPU 61, which is the controller of the system management unit 60. The object detecting process serves as an object position information acquiring unit. The sensor unit 20, composed of the sensors 20a, 20b and 20c, calculates the distance data of the object 3. Then, the sensor unit 20 transmits to the system management unit 60 the object position data (object position information), which includes the sensor identification data that identifies a sensor, the distance data, the detection time data that represents the time of detection of the object 3, and the like. The system management unit 60 is on standby until the object position data detected by the sensor unit 20 is received from the sensor unit 20 (Step S31).

When the object position data is received from any of the sensors 20a, 20b and 20c (YES at Step S31), the MPU 61 stores the object position data in the object position data table 100 (Step S33). At this step, the MPU 61 stores the sensor identification data of the object position data in the sensor identification data field 101, the distance data in the distance field 102, and the detection time data in the sensor detection time field 103.

Next, the MPU 61 compares the distance data stored in the distance field 102 of the object position data table 100 with the upper limit data of the effective detection areas 12 (effective detection areas 12a, 12b and 12c) stored in the upper limit field 113 of the effective area table 110 (Step S35).

Then, the MPU 61 determines whether the distance data stored in the distance field 102 of the object position data table 100 falls within the upper limit data stored in the upper limit field 113 of the effective area table 110 (Step S37). When the distance data is beyond the upper limit data (NO at Step S37), it means that the object 3 is detected outside the effective detection area 12 of the product display shelf unit 1. In this case, the MPU 61 stores “0” in the detection object field 104 of the object position data table 100 (Step S43), and terminates the object detecting process.

When the distance data falls within the upper limit data (YES at Step S37), it means that the object 3 is detected in the effective detection area 12 of the product display shelf unit 1. In this case, the MPU 61 stores “1” in the detection object field 104 of the object position data table 100 (Step S39). Then, the MPU 61 issues an interrupt to the main process (Step S41). Thereafter, the MPU 61 terminates the object detecting process.

In the object detecting process, the MPU 61 stores the object position data (the sensor identification data, distance data, and detection time data) in the object position data table 100. Furthermore, the MPU 61 determines whether the position of the detected object 3 falls within the effective detection area 12 (any of the effective detection areas 12a, 12b and 12c) of the sensor unit 20 (sensors 20a, 20b and 20c ), and stores the result in the object position data table 100. This is because detection targets should be limited to products 2 displayed in the product display shelf unit 1 and objects 3 approaching the product display area 8. In this manner, the positional data of store clerks and customers moving near the product display shelf unit 1, or pillars, walls and any equipment surrounding the product display shelf unit 1 is eliminated from the data of the detection targets, because these are background objects that are unrelated to the detection of objects approaching the product 2.

In the flowchart of FIG. 17, when an interrupt is issued from the object detecting process (YES at Step S1), the MPU 61 executes a RFID tag reading process (Step S3).

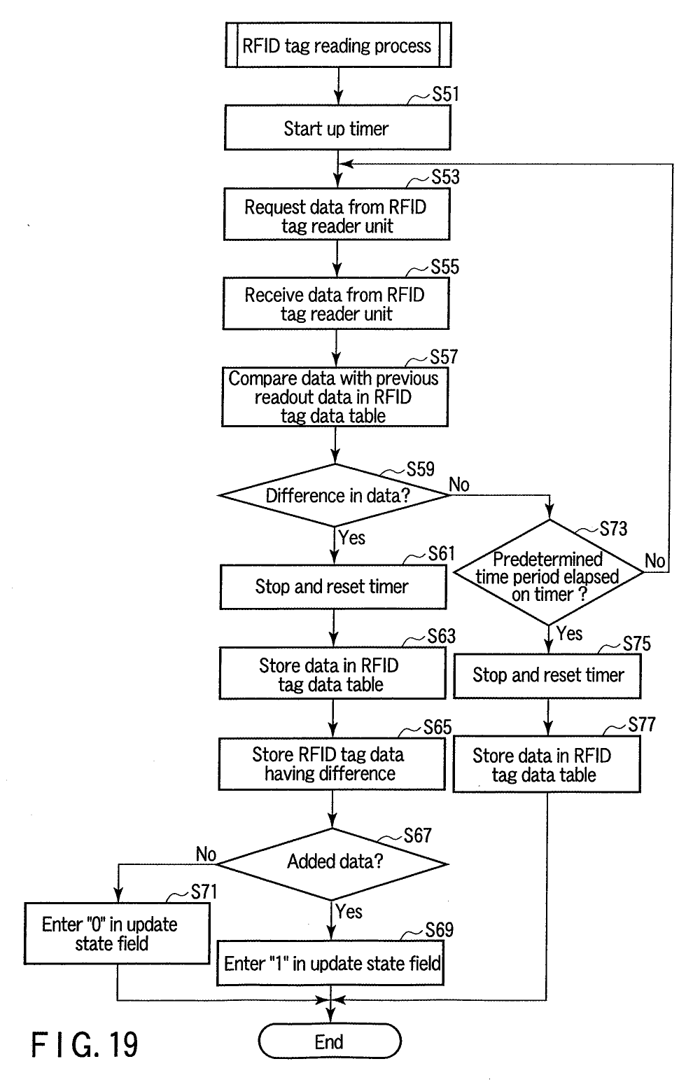

FIG. 19 is a flowchart of the RFID tag reading process executed by the MPU 61, which is the controller of the system management unit 60. The RFID tag reading process serves as an item identification information acquiring unit and a wireless tag readout information acquiring unit. When the item management system 90 is started, the RFID tag reader unit 40 sequentially transmits read waves 44 through the antenna 42 to read a RFID tag 43. Upon receipt of the response waves 45 from the RFID tag 43, the RFID tag reader unit 40 reads data stored in the memory unit 54 of this RFID tag 43, including a tag code, product code and name of the product from the radio waves. The RFID tag reader unit 40 stores the RFID tag readout data composed of these data items in the RFID tag data buffer 160 provided in the memory unit 48 of the RFID tag reader 41. The RFID tag reader unit 40 conducts a search through the RFID tag data buffer 160 by use of the read-out tag code. When the same tag code is stored in the RFID tag data buffer 160, the RFID tag reader unit 40 abandons the RFID tag readout data that is read out. On the other hand, when no tag code the same as the read-out tag code is stored, the RFID tag reader unit 40 does not abandon the RFID tag readout data that is read out. Because no tag codes that are the same are stored, overlapping data reading can be avoided.

The MPU 61 starts up the timer 65 (Step S51). Then, the MPU 61 requests that the RFID tag reader unit 40 transmit the RFID tag readout data read by the RFID tag reader unit 40 (Step S53). On request of the transmission of the RFID tag readout data from the system management unit 60, the RFID tag reader unit 40 transmits the RFID tag readout data stored in the RFID tag data buffer 160 that is provided in the memory unit 48 of the RFID tag reader 41, to the system management unit 60.

When receiving the RFID tag readout data from the RFID tag reader unit 40 (Step S55), the MPU 61 compares the received RFID tag readout data and the previous RFID tag readout data stored in the RFID tag data table 120 (Step S57). Then, the MPU 61 determines whether there is any difference between the RFID tag readout data received at Step S55 and the previous RFID tag readout data (Step S59). According to the present embodiment, the RFID tag readout data including the tag code, product code, and name of the product is used for the comparison and determination. However, because no pair of identical tag codes are stored, only the tag code may be used for the comparison and determination.

When the MPU 61 determines that there is no difference between the RFID tag readout data received at Step S55 and the previous RFID tag readout data (NO at Step S59), the MPU 61 then determines whether the timer indicates that a predetermined time period has elapsed (Step S73). When the MPU 61 determines that a predetermined time period has not yet elapsed (NO at Step S73), the process returns to Step S53, and repeats the operation of Steps S53 to S59. When the MPU 61 determines that a predetermined time period has elapsed (YES at Step S73), the MPU 61 stops and resets the timer (Step S75). Then, the MPU 61 stores the RFID tag readout data received at Step S55 in the RFID tag data table 120 (Step S77). In this operation, the MPU 61 stores the tag code, product code, and name of the product of the RFID tag readout data received at Step S55 in the RFID tag readout data field 121 of the RFID tag data table 120, and also stores the read time data, which indicates the time at which the RFID tag readout data is received from the RFID tag reader unit 40, in the read time field 122. The MPU 61 does not store any data in the difference data field 123 or the update state field 124. Then, the MPU 61 terminates the RFID tag reading process.

When the MPU 61 determines at Step S59 that there is a difference between the RFID tag readout data received at Step S55 and the previous RFID tag readout data (YES at Step S59), the MPU 61 stops and resets the timer (Step S61). Then, the MPU 61 stores the RFID tag readout data received at Step S55 in the RFID tag data table 120 (Step S63). In this operation, the MPU 61 stores the tag code, product code, and name of the product of the RFID tag readout data received at Step S55 in the RFID tag readout data field 121 of the RFID tag data table 120, and the read time data which indicates the time at which the RFID tag readout data is received from the RFID tag reader unit 40 in the read time field 122. Then, the MPU 61 stores the RFID tag readout data that is different from the previous RFID tag readout data in the difference data field 123 (Step S65).

Next, the MPU 61 determines whether the RFID tag readout data stored in the difference data field 123 is data that is added to the previous RFID tag readout data or deleted therefrom (Step S67). In comparison of the latest RFID tag readout data with the previous RFID tag readout data, if the RFID tag readout data stored in the difference data field 123 exists in the latest RFID tag readout data but not in the previous RFID tag readout data, it is added data. On the other hand, if the RFID tag readout data stored in the difference data field 123 exists in the previous RFID tag readout data but not in the latest RFID tag readout data, it is deleted data. When the MPU 61 determines that the RFID tag readout data stored in the difference data field 123 is not added data (NO at Step S67), the MPU 61 enters “0” in the update state field 124 of the RFID tag data table 120 (Step S71). Then, the MPU 61 terminates the RFID tag reading process. The value “0” entered in the update state field 124 means that the RFID tag 43 having this tag code has been removed from the product display shelf unit 1, which is in the communication area of the RFID tag reader unit 40. When the MPU 61 determines that the RFID tag readout data stored in the difference data field 123 is added data (YES at Step S67), the MPU 61 enters “1” in the update state field 124 of the RFID tag data table 120 (Step S71). Then, the MPU 61 terminates the RFID tag reading process. The value “1” entered in the update state field 124 means that the RFID tag 43 having this tag code has been added to the product display shelf unit 1 that is in the communication area of the RFID tag reader unit 40.

In the RFID tag reading process, the MPU 61 acquires the product data such as a product code and the name of the product from the RFID read data, and stores it in the RFID tag data table 120. Moreover, when a new RFID tag 43 is read out, the MPU 61 enters “1” in the update state field 124 of the RFID tag data table 120 to indicate that the data is “added”. On the other hand, when a RFID tag 43 is no longer readable, the MPU 61 enters “0” in the update state field 124 to indicate that the data is “deleted”. Based on the readout result of the RFID tag 43, it can be determined whether a product 2 is loaded onto the product display shelf unit 1, which is the communication area of the RFID tag reader unit 40, or the product 2 is taken away from the product display shelf unit 1. Furthermore, “1” or “0” entered in the update state field 124 of the RFID tag data table 120 means that some change has been made to the RFID tag readout data of the RFID tag 43, which is the readout result.

In the flowchart of FIG. 17, the MPU 61 determines whether any change is made to the RFID tag readout data as a result of the RFID tag reading process (Step S5). More specifically, the MPU 61 determines whether “1” or “0” is entered in the update state field 124 of the latest RFID tag readout data stored in the RFID tag data table 120. When there is no change in the RFID tag readout data, or in other words when neither “1” nor “0” is entered in the update state field 124 (NO at Step S5), it means that no change is made to the result of reading the RFID tag 43 out despite the detection of the object 3. If this is the case, there is a possibility of a malfunction in the sensor unit 20, the RFID tag reader unit 40 or the RFID tag 43. Thus, the MPU 61 audibly or visually outputs warning information such as an error sound or a message to notify the store clerk (Step S9). Thereafter, the MPU 61 returns to the operation of Step S1.

At Step S5, when there is some change to the RFID tag readout data, or in other words when “1” or “0” is entered in the update state field 124 for the latest RFID tag readout data stored in the RFID tag data table 120 (YES at Step S5), the MPU 61 executes the item position identifying process (Step S7).

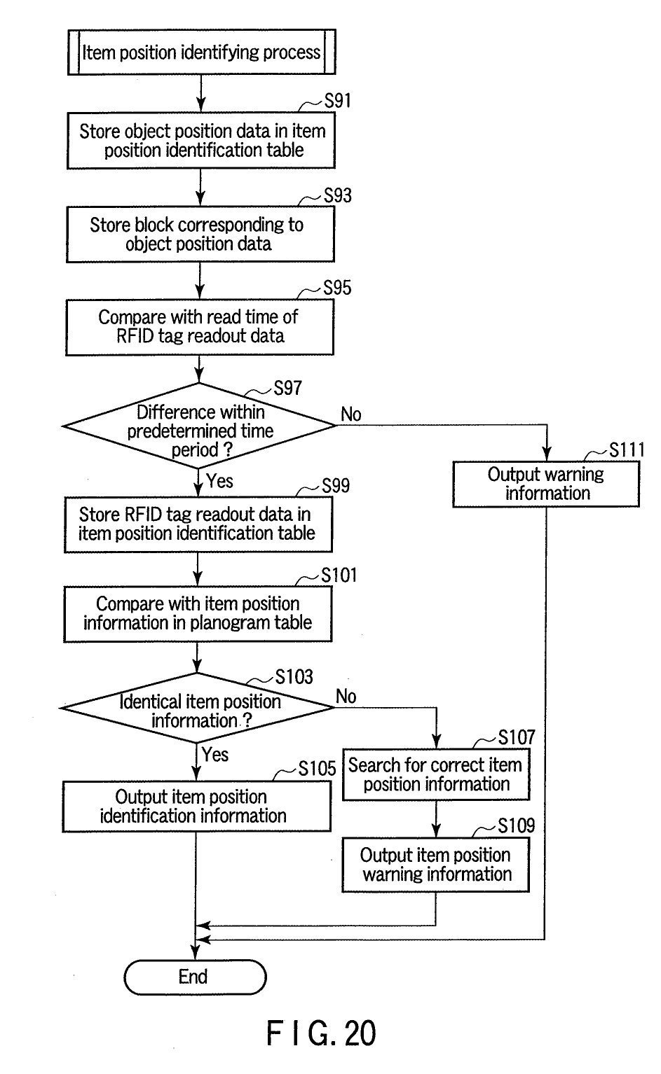

FIG. 20 is a flowchart of the item position identifying process executed by the MPU 61, which is the controller of the system management unit 60. The item position identifying process serves as an item position identifying unit and an item position determining unit. First, the MPU 61 stores, in the item position identification table 130, object position data for which “1” is entered in the detection object field 104 of the object position data table 100 (Step S91). The MPU 61 acquires the shelf data corresponding to the sensor identification data from the shelf field 112 of the effective area table 110, and stores the acquired shelf data in the shelf field 131, the distance data in the distance field 132 and the detection time data in the sensor detection time field 134.

The MPU 61 stores the same shelf data as the shelf data stored in the shelf field 131 of the item position identification table 130, and searches through the planogram table 170 for a block that matches the range data in which the distance data stored in the distance field 132 of the item position identification table 130 is included. Then, the MPU 61 stores the block data that meets the search criteria in the block field 133 of the item position identification table 130 (Step S93). The block data stored in the block field 133 serves as item position identification information.

Next, the MPU 61 compares the detection time data in the sensor detection time field 134 with the read time data for the latest RFID tag readout data in the read time field 122 of the RFID tag data table 120 (Step S95). The MPU 61 determines whether the difference between the detection time data of the sensor detection time field 134 and the read time data of the read time field 122 is within a predetermined time period (Step S97). If it is determined that the difference is not within the time period (NO at Step S97), it means that there is no change in the result of reading the RFID tag 43 despite the detection of the object 3 within the predetermined time period. If this is the case, there is a possibility of a malfunction in the sensor unit 20, the RFID tag reader unit 40 or the RFID tag 43. Thus, the MPU 61 audibly or visually outputs warning information, such as an error sound and message to notify the store clerk (Step S111). Thereafter, the MPU 61 terminates the item position identifying process. For instance, the predetermined time period for the determining process of Step S97 may be set to three seconds so that warning information can be output when there is no change in the result of reading the RFID tag 43 in three seconds after detecting the object 3.

When the MPU 61 determines that the difference between the detection time data in the sensor detection time field 134 and the read time data in the read time field 122 is within the predetermined time period (YES at Step S97), the MPU 61 stores the RFID tag readout data in the item position identification table 130 in association with the object position data stored at Step S91 (Step S99). In this operation, the MPU 61 stores the tag code stored in the difference data field 123 of the RFID tag data table 120 in the tag code field 135 of the item position identification table 130, the product code stored in the difference data field 123 in the product code field 136, the product name data stored in the difference data field 123 in the product name field 137, and the update state data stored in the update state field 124 in the update state field 138.

Next, the MPU 61 compares the item position information stored in the planogram table 170 with the item position identification information stored in the item position identification table 130 (Step S101). In this operation, the MPU 61 conducts a search to determine whether the same product code as the product code stored in the product code field 136 of the item position identification table 130 is stored in the planogram table 170. Then, the MPU 61 compares the block data stored in association with the product code that matches the search criteria with the data block stored in the block field 133 of the item position identification table 130.

The MPU 61 determines whether the block data (item position identification information) stored in the block field 133 of the item position identification table 130 is the same as the block data (item position information) stored in the block field 171 of the planogram table 170 (Step S103). When the MPU 61 determines that the block data of the item position identification table 130 is not the same as the block data of the planogram table 170 (NO at Step S103), the MPU 61 conducts a search through the planogram table 170 to find any block data (item position information) stored in association with the same product code as the product code stored in the product code field 136 of the item position identification table 130 (Step S107). The MPU 61 outputs the item position warning information, based on the block data that matches the search criteria (Step S109).

The display screen 190 illustrated in FIG. 16 is an output example of the item position warning information. The display screen 190 is displayed on a display, which is one example of the output unit 63 of the system management unit 60. The display screen 190 is displayed by using a different color or style for the item position identification information that includes an error, as in the display entry 191, from the one for the correct item position identification information that includes no error. Furthermore, the display screen 190 can notify the store clerk of the display position of a product that is incorrect and the correct display position of this product, by displaying an error message 192 or the like to provide correct item position information that represents the correct display position of the product. The message notifying the error in the display position and the correct display position of the product may be output by voice. After the item position warning information is output, the MPU 61 terminates the item position identifying process.

When the MPU 61 determines that the block data (item position identification information) stored in the block field 133 of the item position identification table 130 is the same as the block data (item position information) stored in the block field 171 of the planogram table 170 (YES at Step S103), the item position identification information stored in the item position identification table 130 is output (Step S105).

The display screen 140 illustrated in FIG. 15 is an example output of the item position identification information. The display screen 140 shows the block data (item position identification information), detection times, names of products, and update state data. When the update state field 138 of the item, position identification table 130 shows “1”, which indicates the data being added, the item position identification information is displayed on the display, which is the output unit 63 of the system management unit 60. This item position identification information is composed of the positional information of the product 2 (item) added to the product display shelf unit 1 (placement unit), the addition time information, the product data that identifies the product 2 such as the name of the product, and display information for “added” that indicates the product being added. When the update state field 138 of the item position identification table 130 shows “0”, which indicates the data being deleted, the item position identification information is also displayed on the display, which is the output unit 63 of the system management unit 60. This item position identification information is composed of the positional information of the product 2 (item) removed from the product display shelf unit 1 (placement unit), the removal time information, the product data that identifies the product 2 such as the name of the product, and display information for “deleted” that indicates the product being removed. By referring to the item position identification information, the store clerk can visually check to see whether products are displayed in the correct positions. After outputting the item position identification information, the MPU 61 terminates the item position identifying process, and awaits the next interrupt from the object detecting process (Step S1).

In the above explanation of the present embodiment, the display screen 140 on the display unit is adopted as an output mode of the item position identification information, but the output mode of the item position identification information is not limited thereto. The item position identification information stored in the item position identification table 130 may be output to a different software program without any change so that the item locations can be controlled in this software program. Moreover, the item position identification information may be printed out by a printing unit such as a printer so that the item locations can be managed with a written report or the like.

According to the first embodiment of the present invention, the MPU 61 identifies the positional information of the product 2 placed in the product display shelf unit 1 in accordance with the object position data output by the object detecting unit of the sensor unit 20, and identifies the identification information of the product 2 in accordance with the RFID tag readout data output by the wireless tag reading unit of the RFID tag reader unit 40. Furthermore, the MPU 61 associates the identified object position data with the RFID tag readout data, and outputs the item position identification information of the product 2 placed in the product display shelf unit 1. Then, the MPU 61 compares the item position identification information with the item position information stored in the item placement position memory unit, and outputs the comparison result. In this manner, the result of comparing the item position identification information with the item position information is output and displayed on the output unit 63 of the system management unit 60 so that the store clerk or any other worker is notified of the accuracy of the task.

### Embodiment 2

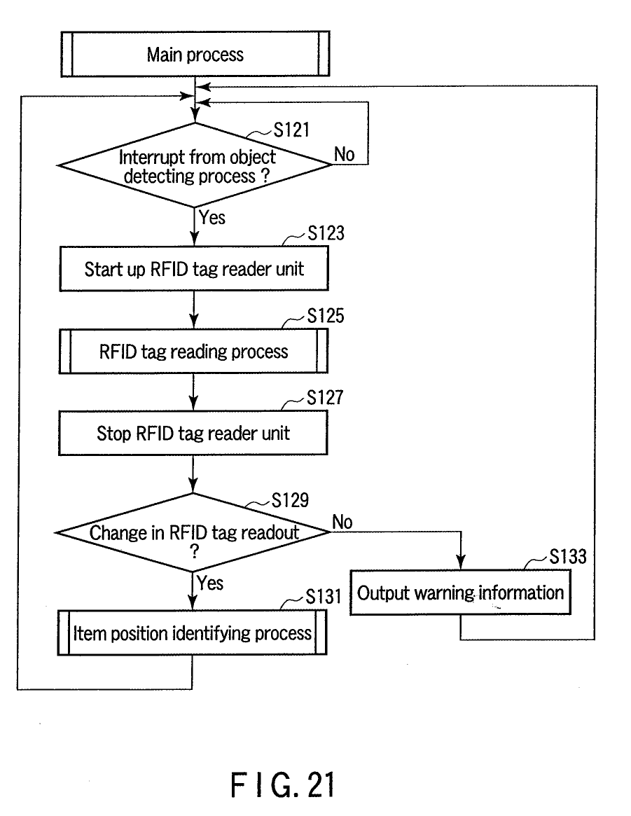

The second embodiment of the present invention will be explained with reference to FIG. 21. Any overlapping portion with the first embodiment will be omitted from the explanation. According to the first embodiment, the RFID tag reader unit 40 starts operating as soon as the system management unit 60 is started. According to the second embodiment, the RFID tag reader unit 40 starts operating when an interrupt is issued from the object detecting process.

FIG. 21 is a flowchart of the main process executed by the MPU 61, which is the controller of the system management unit 60. The MPU 61 of the system management unit 60 is on standby until the object position data is received from the sensor unit 20 and an interrupt is issued from the object detecting process (Step S121). The object detecting process is the same as the process of the first embodiment, and thus is omitted from the explanation.

When an interrupt is issued from the object detecting process (YES at Step S121), the MPU 61 starts the RFID tag reader unit 40 up (Step S123). When the RFID tag reader unit 40 is started, the MPU 61 executes the RFID tag reading process (Step S125). The RFID tag reading process is the same as the process of the first embodiment, and thus is omitted from the explanation.

When the RFID tag reading process is completed, the MPU 61 stops the RFID tag reader unit 40 (Step S127). Next, the MPU 61 determines whether any change is made to the RFID tag readout data as a result of the RFID tag reading process (Step S129). In other words, the MPU 61 determines whether “1” or “0” is entered in the update state field 124 for the latest RFID tag readout data stored in the RFID tag data table 120. When there is no change in the RFID tag readout data, or in other words when neither “1” nor “0” is entered in the update state field 124 (NO at Step S129), it means that no change is made to the readout result of the RFID tag 43 despite the detection of the object 3. If this is the case, there is a possibility of a malfunction in the sensor unit 20, the RFID tag reader unit 40 or the RFID tag 43. Thus, the MPU 61 notifies the store clerk by audibly or visually outputting warning information such as an error sound and a message (Step S133). Then, the MPU 61 returns to Step S121.

When there is a change in the RFID tag readout data in the operation at Step S129, or in other words when “1” or “0” is entered in the update state field 124 of the RFID tag data table 120 for the latest RFID tag readout data (YES at Step S5), the MPU 61 executes the item position identifying process (Step S131). The item position identifying process is the same as the process according to the first embodiment, and thus the explanation is omitted. When the item position identifying process is completed, the MPU 61 is on standby until an interrupt is issued from the object detecting process again (Step S121).

According to the second embodiment of the present invention, the MPU 61 identifies the positional information of the product 2 placed in the product display shelf unit 1 in accordance with the object position data output by the object detecting unit of the sensor unit 20, and also identifies the identification information of the product 2 in accordance with the RFID tag readout data output by the wireless tag reading unit of the RFID tag reader unit 40. Then, the MPU 61 associates the object position data with the RFID tag readout data, and thereby outputs the positional information and identification information of the product 2 placed in the product display shelf unit 1. Radio interference and erroneous reading by the wireless tag reading unit can be avoided because the positional information of items is detected by the object detecting unit that is separated from the wireless tag reading unit. This improves the accuracy in identifying the positions of the items.

Furthermore, the MPU 61 starts up the RFID tag reader unit 40 when an interrupt occurs from the object detecting unit, and the MPU 61 stops the RFID tag reader unit 40 when the RFID tag reading process is completed. Thus, the wireless tag reading unit starts up and reads the RFID tag 43 only when the object detecting unit detects the object 3. In this manner, the power consumption of the RFID tag reader unit 40 can be reduced, and a system with reduced running costs can be realized.

According to the above embodiments, the present invention is applied to an item management system for managing sales products or any other items in a retail store, but the invention is not limited thereto. The present invention may be applied to an item management system for managing parts and materials in a warehouse or the like.

In addition, according to the embodiments, the shelves for displaying products are vertically arranged, but the arrangement is not limited thereto. The present invention may be applied to a table or rack having a substantially horizontal top surface divided into sections to display sales products.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An item managing system, comprising:
an item placement position memory unit that stores item identification information of an item placed on a placement unit and item position information which indicates a position at which the item is placed;
a wireless tag reading unit that reads a wireless tag attached to the item and outputs wireless tag readout information;
an item identification information acquiring unit that acquires the item identification information of the item based on the wireless tag readout information output by the wireless tag reading unit;
an object detecting unit that detects an object approaching the placement unit that carries the item and outputs object position information;
an item position identifying unit that associates the item identification information and the object position information with each other and outputs associated information as item position identification information; and
an item position determining unit that compares the item position identification information output by the item position identifying unit with the item position information stored in the item placement position memory unit and outputs a comparison result.

2. The item managing system according to claim 1, wherein:
the item position determining unit outputs item position warning information when determining that the item position identification information and the item position information are not identical.

3. The item managing system according to claim 1, wherein:
the item position determining unit outputs correct item position information when determining that the item position identification information and the item position information are not identical.

4. The item managing system according to claim 1, wherein:
when a difference between the time at which the object detecting unit detects the object and the time at which the wireless tag reading unit reads the wireless tag is within a predetermined time period, the item position identifying unit associates the object position information and the item identification information with each other and outputs the associated information as the item position identification information.

5. The item managing system according to claim 1, wherein:
the wireless tag reading unit reads the wireless tag when the object position information is acquired from the object detecting unit.

6. The item managing system according to claim 1, wherein the object detecting unit comprises:
a light projecting unit that emits projection light;
a detecting unit that detects reflection light of the projection light reflected from the object; and
an object position calculating unit that calculates the object position information that indicates a position of the object, based on a difference between the time at which the light projecting unit emits the projection light and the time at which the detecting unit detects the reflection light.

7. The item managing system according to claim 1, wherein the object detecting unit comprises:
a light projecting unit that emits projection light;
a detecting unit that detects reflection light of the projection light reflected from the object; and
an object position calculating unit that calculates the object position information that indicates a position of the object, based on a phase difference between the projection light emitted from the light projecting unit and the reflection light detected by the detecting unit.

8. An information processing device, comprising:
an item placement position memory unit that stores item identification information of an item placed on a placement unit and item position information which indicates a position at which the item is placed;
a wireless tag readout information acquiring unit that acquires wireless tag readout information of a wireless tag attached to the item from a wireless tag reading unit;
an item identification information acquiring unit that acquires the item identification information of the item based on the wireless tag readout information;
an object position information acquiring unit that acquires object position information of an object approaching the placement unit that carries the item from an object detecting unit;
an item position identifying unit that associates the item identification information and the object position information with each other and outputs associated information as item position identification information; and
an item position determining unit that compares the item position identification information output by the item position identifying unit with the item position information stored in the item placement position memory unit and outputs a comparison result.

9. The information processing device according to claim 8, wherein:
the item position determining unit outputs item position warning information when determining that the item position identification information and the item position information are not identical.

10. The information processing device according to claim 8, wherein:
the item position determining unit outputs correct item position information when determining that the item position identification information and the item position information are not identical.

11. The information processing device according to claim 8, wherein:
when a difference between the time at which the object detecting unit detects the object and the time at which the wireless tag reading unit reads the wireless tag is within a predetermined time period, the item position identifying unit associates the object position information and the item identification information with each other and outputs the associated information as the item position identification information.

12. The information processing device according to claim 8, wherein:
the wireless tag readout information acquiring unit acquires the wireless tag readout information from the wireless tag reading unit when the object position information acquiring unit acquires the object position information from the object detecting unit.
